(19) United States
(12) Patent Application Publication
(10) Pub. No.: US 2017/0198744 A1
(43) Pub. Date: Jul. 13, 2017

(54) TERMINAL-CONNECTION STRUCTURE

(71) Applicant: HI-LEX CORPORATION, Takarazuka-shi, Hyogo (JP)

(72) Inventor: Ritsu SANO, Nishinomiya-shi, Hyogo (JP)

(73) Assignee: HI-LEX CORPORATION, Takarazuka-shi, Hyogo (JP)

(21) Appl. No.: 15/314,347

(22) PCT Filed: May 28, 2015
(86) PCT No.: PCT/JP2015/065339

§ 371 Date: Nov. 28, 2016

(30) Foreign Application Priority Data
May 29, 2014 (JP) 2014-111438

(51) Int. Cl. F16C 1/14; F16B 7/20

(52) U.S. Cl. CPC F16C 1/14; F16B 7/20

(57) ABSTRACT

A terminal-connection structure is characterized in that a terminal member includes the following: a main terminal-member body that has an attachment section to which terminals on long members are attached and an insertion section that is inserted into the aforementioned insertion opening; and a fitting element that fits together with said insertion section. This terminal-connection structure is also characterized in that: the fitting element is provided with a plurality of elastic prongs and a plurality of restricting parts that restrict axial movement of the fitting element; the insertion section of the main terminal-member body has a shaft section that has a narrowed section that is narrowed in one axial direction; each restricting part has a displaced part that is displaced in the axially inward direction of the fitting element.

### CROSS-REFERENCE TO RELATED APPLICATIONS

This is a national phase application based on the PCT International Patent Application No. PCT/JP2015/065339 filed May 28, 2015, claiming priority to Japanese Patent Application No. 2014-111438 filed May 29, 2014, the entire contents of both of which are incorporated herein by reference.

### TECHNICAL FIELD

The present invention relates to a terminal connection structure.

### BACKGROUND ART

Patent Document 1 discloses a relay mechanism for connecting control cables as one of the structures for connecting a long member, such as a control cable, to a mating member. As illustrated in FIG. 9, a relay mechanism 100 according to Patent Document 1 is in relay-connection with a control cable 101a extending in one direction from the relay mechanism 100 and a control cable 101b extending in the other direction from the relay mechanism 100. Specifically, a cable end 103 of an inner cable 102a of the control cable 101a on one side is locked to one end (left side in FIG. 9) of a joint member 104. An inner cable 102b of the control cable 101b on the other side is locked to an attachment member 105, and the attachment member 105 is inserted into an insertion hole 106 formed in the joint member 104 and is attached to the joint member 104.

The attachment member 105 inserted into the insertion hole 106 of the joint member 104 is provided with a spring member 107, and the spring member 107 includes plate springs 108 partially expanding in the circumferential direction. The spring member 107 elastically deforms when the spring member 107 is inserted into the insertion hole 106 of the joint member 104. After the spring member 107 enters inside the joint member 104, the plate springs 108 of the spring member 107 expand outward, and the attachment member 105 is joined to the joint member 104. As illustrated in FIG. 10, the spring member 107 is press-fitted from the front end of the attachment member 105, and is fitted to and attached to an attachment portion 109, which is a narrowed portion of a shaft-like portion of the attachment member 105. The spring member 107 includes a restricting part 110 provided between the plate springs 108 and placed by steps 109a and 109b formed on both sides in the axial direction of the attachment portion 109, in addition to the plate springs 108 partially expanding in the circumferential direction. When the attachment member 105 is inserted into the insertion hole 106 of the joint member 104, the restricting part 110 restricts axial movement of the spring member 107 with respect to the attachment member 105.

### CITATION LIST

### Patent Literature

PTL1: JP-A 2013-177936 Gazette

### SUMMARY OF INVENTION

### Technical Problem

However, when the spring member 107, which is a fitting piece fitted to a terminal member, is press-fitted from the front end of the attachment member 105, which is a terminal member, the restricting part 110 is plastically deformed depending on the manner in which the spring member 107 is press-fitted, such as a case where the spring member 107 is press-fitted in a state where the axis of the attachment member 105 and the axis of the spring member 107 are inclined with each other. Therefore, the restricting part 110, which is not originally expand outward, may be expanded outward and may not be engaged well with the steps 109a and 109b (especially the step 109b) of the attachment portion 109. In such a case, when the attachment member 105 is inserted into the insertion hole 106 of the joint member 104, the spring member 107 may deviate in the axial direction (right side in FIG. 9) with respect to the attachment portion 109 of the attachment member 105, an end part of the restricting part 110 may get on the step 109b such that the end part covers the step 109b, and thus the attachment member 105 and the joint member 104 may not be well-connected. Consequently, additional post-process and/or correction-process to the spring member 107 may be needed. Therefore, it is necessary to check the engagement state when the spring member 107 is press-fitted to the attachment member 105. In addition, in a case where the engagement state is not appropriate, a process step such as correction is necessary. That is, a structure where the spring member 107 and the attachment member 105 are easily attached together is desired.

In view of the above problems, the object of the present invention is to provide a terminal connection structure capable of easily realizing appropriate fitting between a terminal member main body and a fitting piece fitted to the terminal member main body.

### Solution to Problem

A terminal connection structure according to the present invention includes a terminal member to which a terminal of a long member is attached and which is connected to a mating member, and the terminal member is inserted into an insertion opening part of the mating member and is connected to the mating member. The terminal member includes: a terminal-member main body including an attachment part to which the terminal of the long member is attached, and an insertion part which extends from the attachment part and is inserted into the insertion opening part; and a fitting piece which is fitted to the insertion part of the terminal-member main body. The fitting piece includes: elastic parts which deform elastically when the elastic parts are inserted into the insertion opening part and are engaged with an inside engagement part of the mating member by expanding after the elastic parts are inserted into the insertion opening part, and restricting parts which extend in an axial direction of the insertion part between the elastic parts and restrict movement of the fitting piece in the axial direction of the insertion part with respect to the insertion part by engaging the terminal-member main body to end of the restricting parts in both side. The insertion part includes a shaft part which extends in the axial direction and is provided with a reduced-diameter part that is reduced in diameter toward one side in the axial direction. The restricting part includes a displacement part which is displaced inwardly in an axial direction of the fitting piece, and the fitting piece is attached to the terminal-member main body with the displacement part positioned along the reduced-diameter part.

In addition, it is preferable that engagement parts which are engaged with the restricting parts are provided on the front end side and the rear end side of the shaft part, a front end part and a rear end part of each of the restricting parts are engaged with the engagement parts, and the reduced-diameter part is provided adjacent to at least one engagement part.

In addition, it is preferable that the reduced-diameter part is a tapered part reduced in diameter toward a rear end, and the displacement part is displaced toward the inside of the fitting piece correspondingly to the tapered part.

In addition, it is preferable that each of the restricting parts has spring elasticity, and the displacement part is displaced so as to be brought into contact with the reduced-diameter part by an elastic force due to the spring elasticity in a state where the fitting piece is mounted to the terminal-member main body.

### Advantageous Effects of Invention

With the terminal connection structure according to the present invention, it is possible to restrict axial movement of the fitting piece, which includes the elastic parts and the restricting parts and is fitted to the terminal-member main body, with respect to the terminal-member main body.

### BRIEF DESCRIPTION OF DRAWINGS

FIG. 1 shows a terminal connection structure according an embodiment of the present invention.

FIG. 2 is an exploded view of the terminal connection structure in FIG. 1.

FIG. 3(A) is a perspective view of a terminal-member main body used in the terminal connection structure in FIG. 1, and FIG. 3(B) is a side view of the terminal-member main body in FIG. 3(A).

FIG. 4(A) is a side view of a fitting piece used in the terminal connection structure in FIG. 1, FIG. 4(B) is a view of the fitting piece in FIG. 4(A) seen from a base end side, and FIG. 4(C) is a bottom view of the fitting piece in FIG. 4(A).

FIGS. 5(A) to 5(C) show states of connecting the terminal member used in the terminal connection structure in FIG. 1 to a mating member.

FIG. 6(A) is a side view of the terminal member in which the fitting piece shown in FIGS. 4(A) to 4(C) are attached to the terminal-member main body shown in FIGS. 3(A) and 3(B), and FIG. 6(B) is a side view of the terminal member in which the fitting piece in FIG. 6(A) is attached in a state where a restricting part of the fitting piece is deformed.

FIG. 7(A) shows a state before a fitting piece is fitted to an insertion part in a conventional terminal connection structure, FIG. 7(B) shows a state where the fitting piece in FIG. 7(A) is fitted in a state where the fitting piece is inclined with respect to a front end part of the insertion part, FIG. 7(C) shows a state where the fitting piece in FIG. 7(A) is pushed in in a state where the fitting piece is inclined with respect to the front end part of the insertion part and a restricting part is deformed, and FIG. 7(D) shows a state where the fitting piece in FIG. 7(A) is fitted to the insertion part in a state where the restricting part is plastically deformed.

FIG. 8(A) shows a state of the fitting piece in FIG. 7(A) when an elastic part of the fitting piece is brought into contact with an opening edge of an insertion opening part of the mating member, and FIG. 8(B) shows a state where the fitting piece in FIG. 8(A) deviates in the axial direction with respect to the insertion part and comes off from a fitting portion.

FIG. 9 shows a conventional relay mechanism of control cables.

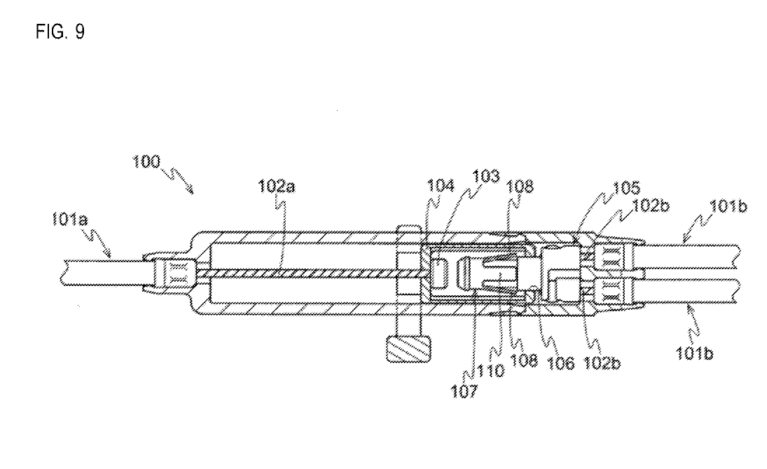

FIG. 10 is an exploded view of the relay mechanism in FIG. 9.

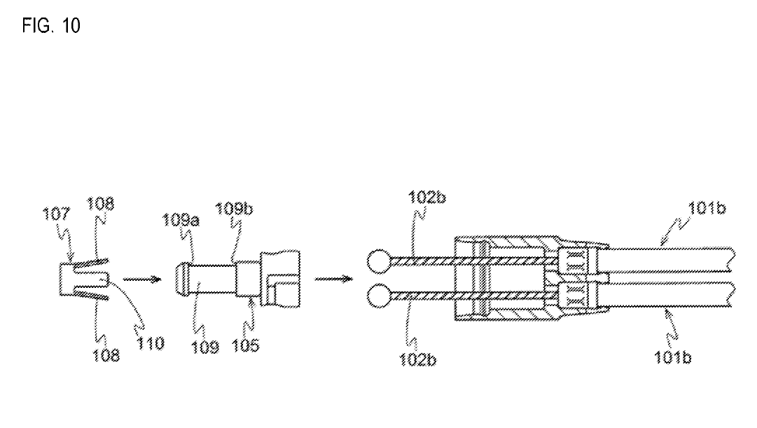

### DESCRIPTION OF EMBODIMENTS

Hereinafter, a terminal connection structure according to the present invention will be described in detail with reference to the accompanying drawings.

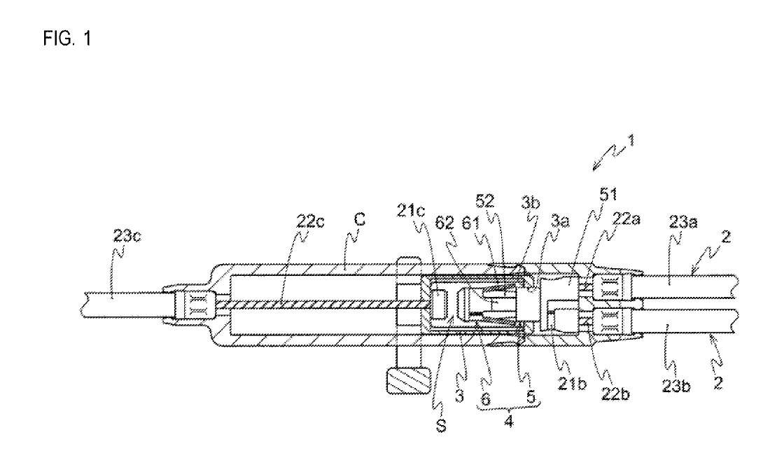

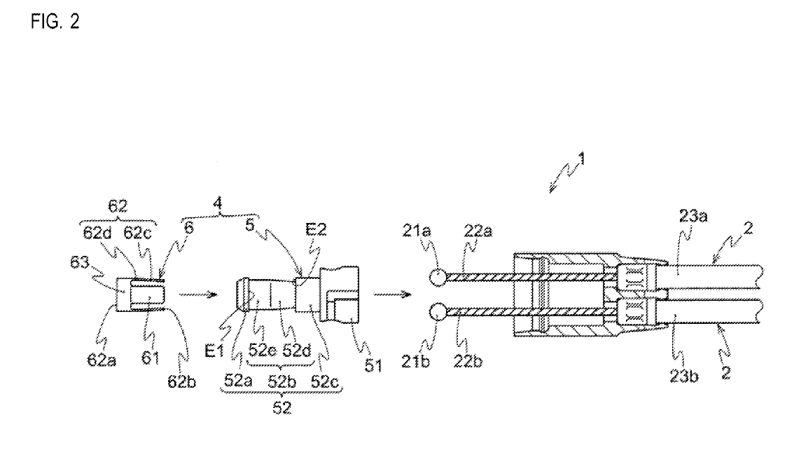

As illustrated in FIGS. 1 and 2, the terminal connection structure 1 according to the present invention includes a terminal member 4 to which terminals 21a and 21b of long members 2 are attached and which is connected to a mating member 3. The terminal member 4 is inserted into an insertion opening part 3a of the mating member 3 and is connected to the mating member 3. The terminal connection structure 1 is used for connecting the mating member 3 and the long member 2 via the terminal member 4, and can be applied, for example, to a vehicular seat operation device, a vehicular fuel lid opening and closing mechanism, and a vehicular trunk opening and closing mechanism which interconnect control cables mutually. In addition, the terminal connection structure 1 can be applied to usage other than vehicles.

The long member 2 has a predetermined length, and is used for connecting distant spots via the terminal member 4. In addition, the long member 2 is not particularly limited as long as the long member 2 connects spots separated from each other; however, the long member 2 may be a control cable including an inner cable 22a or 22b and an outer casing 23a or 23b as illustrated in FIGS. 1 and 2, or may be a rod-like member transmitting an operation force. Note that the terminals 21a and 21b on one end side of the inner cables 22a and 22b of the control cables are attached to the terminal member 4 in the present embodiment; however, terminals of the outer casings 23a and 23b may be attached to the terminal member 4. In addition, in FIG. 1, two long members 2 are attached to the terminal member 4; however, the number of long members 2 attached to the terminal member 4 is not particularly limited, and the number may be one or may be three or more.

The terminal member 4 is connected to the mating member 3 and functions as a connecting part that connects the long member 2 to the mating member 3. The terminal member 4 will be described later in detail. The manner of attaching the terminals 21a and 21b of the long members 2 to the terminal member 4 is not particularly limited. The terminals 21a and 21b of the long members 2 may be attached by engagement as illustrated in the present embodiment, or may be attached by another known fixation means such as casting, welding, or screwing. As described above, the terminal member 4 to which the long member 2 is attached is inserted into the insertion opening part 3a of the mating member 3 and is connected to the mating member 3.

The mating member 3 is a connection target to which the terminal member 4 is connected, and includes the insertion opening part 3a into which the terminal member 4 can be inserted as illustrated in FIG. 1. The shape and the structure of the mating member 3 is not limited as long as the terminal member 4 can be connected to the mating member 3 according to usage of the terminal connection structure 1. In addition, the shape of the insertion opening part 3a can be appropriately changed according to the shape of the terminal member 4 to be inserted; however, as will be described later, the size of the insertion opening part 3a is set such that elastic parts 61 of a fitting piece 6 of the terminal member 4 are brought into contact with an opening edge of the insertion opening part 3a and are displaced inward in the radial direction when the terminal member 4 is inserted into the insertion opening part 3a, the elastic parts 61 are engaged with an inside engagement part 3b provided on the periphery of the insertion opening part 3a when the elastic parts 61 expand after insertion of the terminal member 4 has been completed, and thus the terminal member 4 is prevented from coming off from the mating member 3.

Note that in the present embodiment, as illustrated in FIG. 1, the mating member 3 is illustrated as an substantially cylindrical joint member having an internal space S into which the terminal member 4 can be inserted. In the embodiment illustrated in FIG. 1, the terminal member 4 is connected to one side of the mating member 3 (joint member), and another inner cable 22c is connected to the other side of the mating member 3. Thus, the other inner cable 22c and the long members 2 are interconnected by means of the mating member 3 (joint member). Although the connection structure between the mating member 3 and the terminal member 4 will be described later, in the case of the present embodiment, the mating member 3 is configured such that when the other inner cable 22c is pulled, the two long members 2 can be pulled via the mating member 3 (joint member). More specifically, as illustrated in FIG. 1, the terminal member 4 is connected to one end side of the mating member 3, a terminal 21c of the other inner cable 22c is locked to the other end side of the mating member 3, and the mating member 3 is slidably accommodated in a cylindrical joint case C.

The joint case C accommodates the mating member 3 engaged with the terminal member 4. Terminals of the two outer casings 23a and 23b are fixed to a member on one side (right side in FIG. 1) of the joint case C, a terminal of an outer casing 23c through which the other inner cable 22c is inserted is fixed to a member on the other side (left side in FIG. 1) of the joint case C, and thus a relay mechanism is constituted. As described above, such a relay mechanism can be applied to, for example, a vehicular seat operation device. Note that the relay mechanism described in the present embodiment is the one which interconnects one long member (the outer casing 23c or the inner cable 22c) and each of the two long members 2 (the outer casing 23a and the inner cable 22a; or the outer casing 23b and the inner cable 22b). However, the relay mechanism is not limited to the above structure. The relay mechanism may be applied to a relay mechanism that interconnects one long member and one long member such as a fuel lid opening and closing mechanism, or may be a mechanism that connects two long members and two long members. In addition, in the present embodiment, the terminal member 4 is connected to only one end side of the mating member 3. However, the terminal members 4 may be connected to the both ends of the mating member 3. Alternatively, the terminal member 4 may be attached to a bracket or the like in order to connect a terminal of the long member 2.

Next, the structure of the terminal member 4 and the connection structure between the terminal member 4 and the mating member 3 will be described. As described in FIGS. 1 and 2, the terminal member 4 includes a terminal-member main body 5 and a fitting piece 6 attached to the terminal-member main body 5. The terminal-member main body 5 is a member for connecting the long members 2 to the mating member 3. The terminal-member main body 5 includes an attachment part 51 to which the terminals 21a and 21b of the long members 2 are attached, and an insertion part 52 extending from the attachment part 51 and inserted into the insertion opening part 3a.

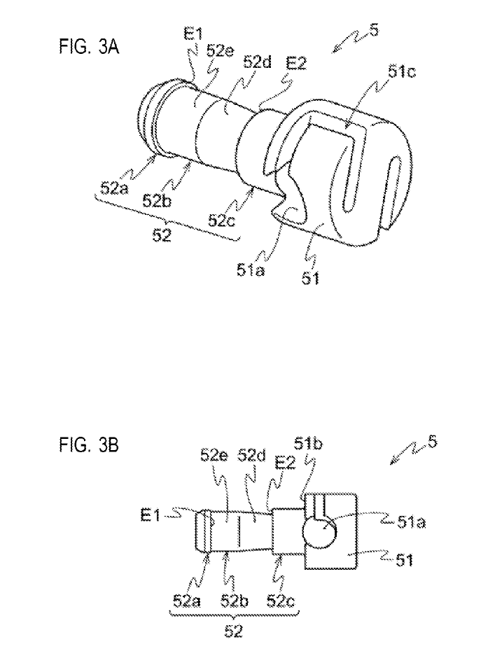

The attachment part 51 of the terminal-member main body 5 is a portion to which the terminals 21a and 21b of the long members 2 are attached. The shape of the attachment part 51 may be any shape as long as the terminals 21a and 21b of the long members 2 can be attached to the attachment part 51. The outer shape of the attachment part 51 may be substantially columnar as illustrated in FIGS. 2, 3(A), and 3(B), or may be prismatic or another shape. As described above, the manner of attaching the terminals 21a and 21b of the long members 2 to the attachment part 51 is not particularly limited, and the terminals 21a and 21b of the long members 2 are attached by a known fixation means such as engagement. In the case of attaching the terminals 21a and 21b of the long members 2 to the attachment part 51 by engagement, the engagement and fixing method is not particularly limited. The terminals 21a and 21b may be engaged with the attachment part 51 from the outer circumference side of the attachment part 51. In a case where there is only one long member 2, a cavity may be provided inside the insertion part 52 of the terminal-member main body 5, and the terminal 21a or 21b may pass through the insertion part 52 and may be engaged with the attachment part 51. Note that in the present embodiment, as illustrated in FIGS. 3(A) and 3(B), the attachment part 51 of the terminal-member main body 5 is formed to be a columnar shape larger than the insertion part 52, and locking recess parts 51a, to which cable ends (terminals 21a and 21b) of the inner cables 22a and 22b of the control cables are locked, are formed on the attachment part 51. The locking recess part 51a is opened on an end surface 51b (see FIG. 3(B)) on the side from which the insertion part 52 extends, the end surface 51b being one of the both end surfaces of the attachment part 51. Since the locking recess parts 51a are provided, the axial length of the attachment part 51 can be made shorter and the terminal-member main body 5 can be smaller and more lightweight. As described in FIGS. 3(A) and 3(B), the locking recess part 51a is opened to the outer circumference side and the end surface 51b of the attachment part 51. The terminals 21a and 21b of the inner cables 22a and 22b are inserted from the outer peripheral side of the attachment part 51 and locked to the locking recess parts 51a, and the inner cables 22a and 22b are attached along guide grooves 51c (see FIG. 3(A)) guiding the inner cables 22a and 22b when the inner cables 22a and 22b are attached.

In addition, the shape of the terminal-member main body 5 illustrated in FIGS. 3(A) and 3(B) is only an example, and the sizes (sizes in the axial direction and around the axis) of the attachment part 51 and the insertion part 52 are not particularly limited. In addition, the shape of the locking recess part 51a is not limited to the illustrated shape, and may be appropriately changed according to the shape or the like of the terminals 21a and 21b of the long members 2. In addition, in the present embodiment, as illustrated in FIG. 3(A), the guide groove 51c extends from the locking recess part 51a along the circumferential direction of the attachment part 51, and then extends in the axial direction of the attachment part 51. However, the shape of the guide groove 51c is not particularly limited to the illustrated shape. Furthermore, the engagement structure of the terminals 21a and 21b of the long members 2 to the attachment part 51 can be appropriately changed according the number of long members 2 to be used, the shapes or the sizes of the terminals 21a and 21b, or the shape or the size of the terminal-member main body 5, and a known engagement structure can be used.

As illustrated in FIGS. 2, 3(A), and 3(B), the insertion part 52 of the terminal-member main body 5 extends from the attachment part 51 coaxially with the attachment part 51. As illustrated in FIG. 1, the insertion part 52 is a portion where the fitting piece 6 is fitted to and inserted into the insertion opening part 3a of the mating member 3. The insertion part 52 includes a shaft part 52b extending in the axial direction. The shaft part 52b is a shaft-shaped portion of the insertion part 52, and the fitting piece 6 is attached to the shaft part 52b. In the present embodiment, as illustrated in FIGS. 3(A) and 3(B), the insertion part 52 includes a rear end portion 52c provided on the rear end side of the insertion part 52 and having a size capable of being inserted into the insertion opening part 3a, the shaft part 52b extending from the rear end portion 52c to the front end side, and a front end portion 52a provided on the front end side of the shaft part 52b. In the present embodiment, as illustrated in FIGS. 3(A) and 3(B), the front end portion 52a includes an substantially columnar part, and a truncated cone-shaped part formed on the substantially columnar part on the side of the front end of the insertion part. The rear end portion 52c is formed into an substantially columnar shape coaxially with the attachment part 51 on the front end side of the attachment part 51. The rear end portion 52c is formed to have substantially the same diameter as the diameter of the substantially columnar part of the front end portion 52a. In the present embodiment, the shaft part 52b is formed to have the diameter smaller than the diameter of the substantially columnar part of the front end portion 52a and the diameter of the rear end portion 52c. Note that, as used herein, “front end” refers to a free end of the insertion part 52, and “rear end” refers to the end part on the side opposite to the front end of the insertion part 52. Similarly, the front end side and the rear end side of the shaft part 52b mean the same sides as the front end side (left side in FIGS. 3(A) and 3(B)) of the insertion part 52 and the rear end side (right side in FIGS. 3(A) and 3(B)) of the insertion part 52, respectively. In addition, as will be described later, a front end part and a rear end part of a restricting part 62 mean an end part of the restricting part 62 on the front end side of the insertion part 52 and an end part of the restricting part 62 on the rear end side of the insertion part 52, respectively, when the fitting piece 6 is attached to the shaft part 52b.

As will be described later, the shaft part 52b is a portion to which the fitting piece 6 is fitted, and includes engagement parts E1 and E2 on the front end side and the rear end side of the shaft part 52b, respectively, in order to prevent the fitting piece 6 fitted to the shaft part 52b from moving in the axial direction. The engagement parts E1 and E2 are portions with which the both ends of each of the restricting parts 62 to be described later are brought into contact in the axial direction, and which are engaged with the restricting parts 62. The engagement parts E1 and E2 restrict axial movement of the fitting piece 6. In the present embodiment, the engagement part E1 on the front end side is illustrated as a step between the front end portion 52a and the shaft part 52b, and the engagement part E2 on the rear end side is illustrated as a step between the shaft part 52b and the rear end portion 52c. However, the engagement parts E1 and E2 are not limited to the step between the front end portion 52a of the insertion part 52 and the shaft part 52b and the step between the rear end portion 52c of the insertion part 52 and the shaft part 52b, respectively. The structures of the engagement parts E1 and E2 are not particularly limited as long as the engagement parts E1 and E2 can be engaged with the fitting piece 6 so as to restrict axial movement of the fitting piece 6, as will be described later.

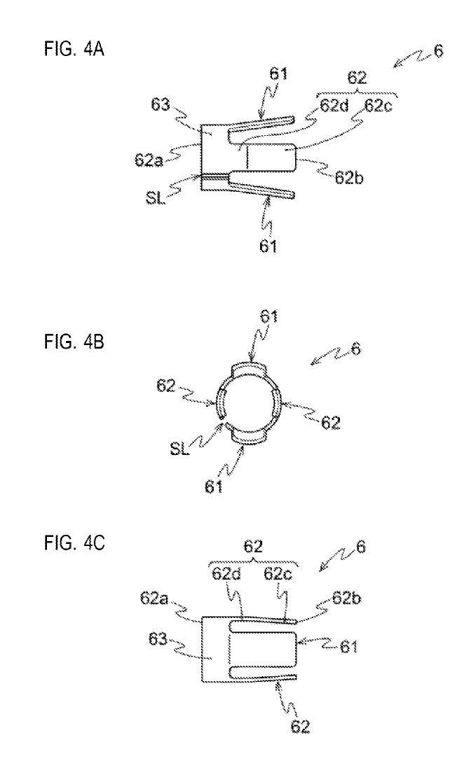

Next, the fitting piece 6 attached to the insertion part 52 will be described. The fitting piece 6 has a function of preventing the terminal member 4 from coming out of the insertion opening part 3a during operation or the like, after the fitting piece 6 is fitted to and attached to the insertion part 52 and the insertion part 52 is inserted into the insertion opening part 3a. As illustrated in FIGS. 4(A) to 4(C), the fitting piece 6 includes elastic parts 61 and restricting parts 62 provided between the elastic parts 61 and extending in the axial direction of the insertion part 52. As illustrated in FIG. 1, elastic parts 61 and the restricting parts 62 are alternately arranged in the direction around the axis so that the fitting piece 6 is coaxial with the shaft part 52b when the fitting piece 6 is fitted to the shaft part 52b of the insertion part 52 of the terminal-member main body 5. The fitting piece 6 is configured to be elastically deformable when the fitting piece 6 is fitted to the shaft part 52b and/or when the fitting piece 6 is inserted into the insertion opening part 3a. More specifically, the fitting piece 6 according to the present embodiment is configured such that, on the front end side (the front end side (left side in FIGS. 4(A) and 4(C)) of the shaft part 52b when the fitting piece 6 is attached to the shaft part 52b) of the fitting piece 6, the elastic parts 61 and the restricting parts 62 are connected in the circumferential direction at a substantially ring-shaped base part 63. Slit SL is provided along the axial direction on the substantially ring-shaped base part 63 so that the base part 63 can be expanded in diameter when the fitting piece 6 is fitted from the front end portion 52a of the insertion part 52. The fitting piece 6 may be fitted to the insertion part 52 in any manner as long as the fitting piece 6 is fitted so as not to come off from the insertion part 52. For example, as illustrated in FIG. 2, the rear end side (right side in FIG. 2) of the fitting piece 6 is press-fitted and put in from the side of the front end portion 52a of the insertion part 52 while the restricting parts 62 and the base part 63 are expanded outward by using a tool or the like, and the restricting parts 62 and the base part 63 are returned to the original state after the fitting piece 6 is put in. Thereby, the fitting piece 6 is fitted.

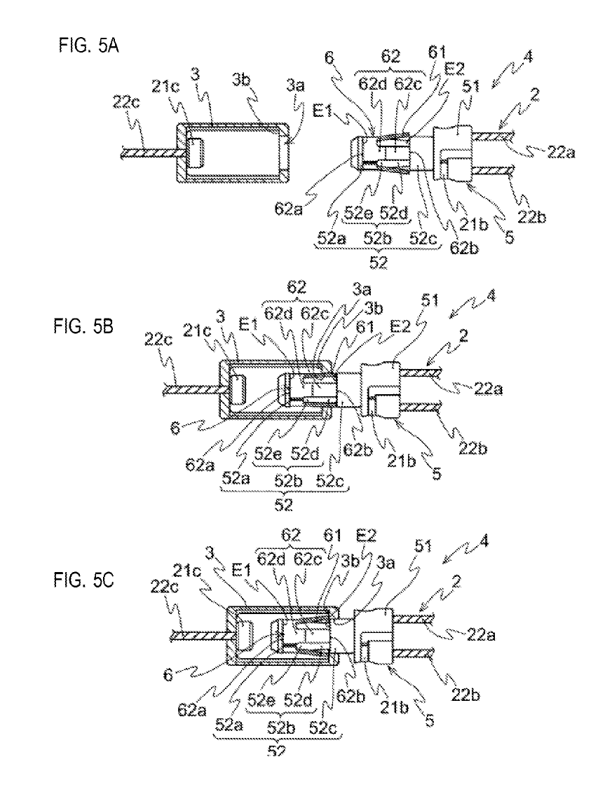

As illustrated in FIGS. 5(A) to 5(C), elastic parts 61 elastically deforms upon insertion into the insertion opening part 3a, expands after the elastic parts 61 are inserted into the insertion opening part 3a, and are engaged with the inside engagement part 3b of the mating member 3. Since the elastic parts 61 are engaged with the inside engagement part 3b of the mating member 3, the terminal-member main body 5 to which the fitting piece 6 is fitted is prevented from being come out of the insertion opening part 3a of the mating member 3, for example, when the long member 2 is operated. In the present embodiment, as illustrated in FIGS. 4(A), and 5(A) to 5(C), the elastic part 61 is formed into a plate-spring shape expanding outward from the base part 63 to the rear end side of the shaft part 52b, and (two) elastic parts 61 is provided such that the elastic parts 61 are separated from each other at nearly equal intervals in the circumferential direction. As illustrated in FIG. 5(A), the elastic parts 61 expand outward so as to be brought into contact with the opening edge of the insertion opening part 3a upon insertion into the insertion opening part 3a. As illustrated in FIG. 5(B), after the elastic parts 61 are brought into contact with the opening edge of the insertion opening part 3a, the insertion part 52 is further pushed into the insertion opening part 3a and, thereby, the elastic parts 61 which has been expanded outward elastically deform toward the axis of the insertion part 52 so that the elastic parts 61 are inserted into the insertion opening part 3a. After the elastic parts 61 are inserted into the insertion opening part 3a, the elastically deformed elastic parts 61 return to the original state and expand outward as illustrated in FIG. 5(C). As illustrated in FIG. 5(C), the elastic parts 61 which have returned to the original state can be engaged with the inside engagement part 3b of the mating member 3. Even when the long member 2 attached to the terminal member 4 is pulled, the terminal-member main body 5 will not come out of the insertion opening part 3a. For example, the inner cable 22c on the left side in FIG. 1 is pulled to the left, the mating member 3 also moves to the left in the joint case C. When the mating member 3 moves to the left, the terminal member 4 also moves to the left together with the mating member 3 as the elastic parts 61 are engaged with the inside engagement part 3b. Thus, the two long members 2 (inner cables 22a and 22b) on the right side in FIG. 1 are operated.

In the fitting piece 6 illustrated in FIGS. 4(A) to 4(C), the elastic part 61 linearly extends from the substantially ring-shaped base part 63; however, the shape of the elastic part 61 is not particularly limited as long as the elastic part 61 elastically deforms when the insertion part 52 is inserted into the insertion opening part 3a, is engaged with the inside engagement part 3b of the mating member 3 after the insertion part 52 is inserted, and thus can prevent the terminal-member main body 5 from coming out of the insertion opening part 3a. In addition, the number of elastic parts 61 provided at the fitting piece 6 is not particularly limited as long as the elastic parts 61 are engaged with the inside engagement part 3b of the mating member 3 so as to prevent the terminal-member main body 5 from coming out of the insertion opening part 3a of the mating member 3. The number of elastic parts 61 may be two as illustrated in FIGS. 4(A) to 4(C), or may be three or more.

As illustrated in FIG. 5(B), since the elastic part 61 is inserted while being in contact with the opening edge of the insertion opening part 3a when the insertion part 52 is inserted into the insertion opening part 3a, the elastic part 61 receives a reaction force from the opening edge of the insertion opening part 3a in the direction (toward the right side in FIG. 5(B)) opposite to the insertion direction (toward the left side in FIG. 5(B)). Therefore, restricting parts 62, where the both ends in the axial direction of the fitting piece 6 are engaged with the terminal-member main body 5, is provided in order to prevent the fitting piece 6 from deviating in the axial direction with respect to the insertion part 52 due to the reaction force received by the elastic part 61 and in the direction opposite to the insertion direction.

The restricting part 62 restricts axial movement of the fitting piece 6 with respect to the insertion part 52. Here, “restrict axial movement” in the description of the restricting part 62 means to restrict axial movement of the fitting piece 6 which causes the fitting piece 6 to come off from the insertion part 52 (shaft part 52b) as described above. Note that “axial movement” herein does not include a case where the fitting piece 6 axially moves on the shaft part 52b without coming off from the shaft part 52b since the axial length of the restricting part 62 is shorter than that of the shaft part 52b, for example, in a case where the fitting piece 6 axially moves a little on the shaft part 52b due to a small clearance between the end of the fitting piece 6 and the end of the shaft part 52b of the insertion part 52.

In the present embodiment, as illustrated in FIGS. 5(A) to 5(C), a front end part 62a of the restricting part 62 is engaged with the engagement part E1 on the front end side of the shaft part 52b, and a rear end part 62b of the restricting part 62 is engaged with the engagement part E2 on the rear end side of the shaft part 52b. Therefore, when the insertion part 52 is inserted into the insertion opening part 3a, the rear end part 62b of the restricting part 62 is engaged with the engagement part E2 on the rear end side of the shaft part 52b, and thus the fitting piece 6 is restricted, by the restricting part 62, from moving to the rear end side with respect to the insertion part 52. When the elastic part 61 is engaged with the inside engagement part 3b of the mating member 3 through operation of the long member 2 or the like after the insertion part 52 is inserted into the insertion opening part 3a, a force in the direction of moving the fitting piece 6 to the front end side of the insertion part 52 with respect to the insertion part 52 is applied to the fitting piece 6 due to a reaction force from the inside engagement part 3b. However, since the front end part 62a of the restricting part 62 is engaged with the engagement part E1 on the front end side of the shaft part 52b, the fitting piece 6 is restricted from moving to the front end side with respect to the insertion part 52.

The restricting part 62 is provided between the elastic parts 61 provided at the fitting piece 6. That is, the restricting part 62 is provided between the elastic parts 61 such that the restricting part 62 is separated from or adjacent to the elastic part 61 in the circumferential direction. Similarly to the elastic part 61, the restricting part 62 is a plate-shaped member extending from the ring-shaped base part 63. In the present embodiment, the restricting part 62 has an substantially rectangular shape. In the present embodiment, as illustrated in FIGS. 4(A) to 4(C), two restricting parts 62 are provided in spaces between the two elastic parts 61. However, the number of restricting parts 62 is not particularly limited. For example, in a case where four elastic parts 61 are provided, it is not necessary to provide a restricting part 62 in each of the four spaces between the elastic parts 61 as long as at least two restricting parts 62 are provided.

Next, the shaft part 52b and the restricting part 62 will be described in more detail.

As illustrated in FIGS. 2, 3(A), and 3(B), the shaft part 52b includes a reduced-diameter part 52d reduced in diameter and provided on one side in the axial direction. The reduced-diameter part 52d is a portion of the shaft part 52b, where its diameter is reduced in order to allow a displacement part 62c which is displaced inward in the radial direction of the fitting piece 6 to be positioned along the reduced-diameter part 52d when the fitting piece 6 is attached to the shaft part 52b. The shape or the structure of the reduced-diameter part 52d can be changed according to the shape or the structure of the displacement part 62c as long as the reduced-diameter part 52d is reduced in diameter at least on a part of the outer circumference of the shaft part 52b so that the displacement part 62c is positioned along the reduced-diameter part 52d. The reduced-diameter part 52d may be formed at an axial position corresponding to the position where the displacement part 62c of the restricting part 62 is formed, and may be provided on one side in the axial direction, that is, at least one of the front end side and the rear end side of the shaft part 52b. In the present embodiment, as illustrated in FIGS. 2, 3(A), and 3(B), the shaft part 52b includes a columnar part 52e, and the reduced-diameter part 52d smaller in diameter than the columnar part 52e. In addition, the reduced-diameter part 52d is illustrated as a tapered part reduced in diameter toward the rear end of the shaft part 52b, and the reduced-diameter part 52d is provided adjacent to the engagement part E2 on the rear end side. Furthermore, in the present embodiment, as illustrated in FIGS. 3(A) and 3(B), the engagement part E1 on the front end side illustrated as a step is formed between the front end portion 52a and the columnar part 52e of the insertion part 52, and the engagement part E2 on the rear end side is formed as a step between the rear end portion 52c and the end part of the reduced-diameter part 52d illustrated as a tapered part of the insertion part 52. In the present embodiment, the engagement part E1 on the front end side is formed as a step with the height, with respect to the end part of the columnar part 52e of the shaft part 52b, nearly equal to the thickness of the plate member of the fitting piece 6, and the engagement part E2 on the rear end side is formed as a step with the height, with respect to the rear end of the reduced-diameter part 52d of the shaft part 52b, higher than the height of the step on the engagement part E1 side. Note that the reduced-diameter part 52d may have a shape other than a tapered shape. For example, the reduced-diameter part 52d may be reduced in diameter stepwise, or may be reduced in diameter in a groove shape. In addition, in the present embodiment, as illustrated in FIG. 3(A), the reduced-diameter part 52d is reduced in diameter continuously in the circumferential direction of the shaft part 52b; however, the reduced-diameter part 52d may be reduced in diameter only on part in the circumferential direction.

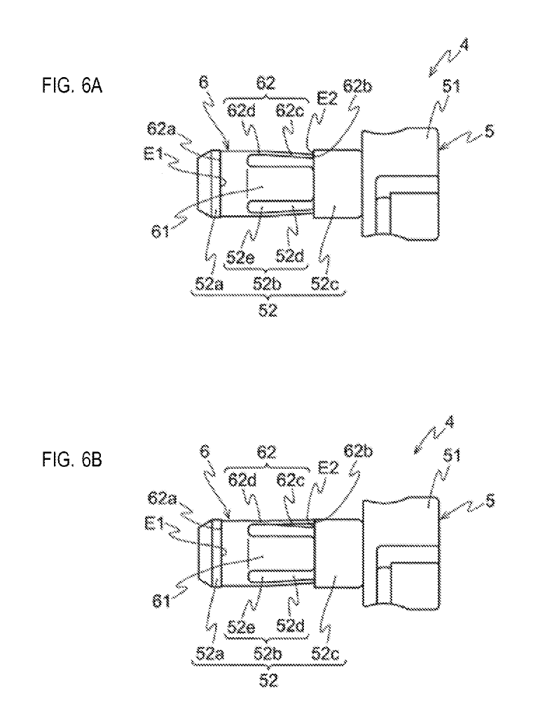

The restricting part 62 includes the displacement part 62c correspondingly to the above-described reduced-diameter part 52d. As illustrated in FIG. 6(A), the fitting piece 6 is attached to the terminal-member main body 5 such that the displacement part 62c is positioned along the reduced-diameter part 52d. The displacement part 62c is disposed along the reduced-diameter part 52d when the fitting piece 6 is attached to the terminal-member main body 5. Since the displacement part 62c is displaced in advance inward in the radial direction, even if the restricting part 62 is displaced outward in the radial direction and its diameter is increased when the fitting piece 6 is attached to the terminal-member main body 5, the restricting part 62 returns to the original state before the diameter is increased due to elasticity of the restricting part 62. Therefore, the restricting part 62 can be engaged with the engagement part E2. By more securely engaging the restricting part 62 with the terminal-member main body 5, the terminal member 4 and the mating member 3 can be connected without causing the restricting part 62 to get on the engagement part. Here, “along the reduced-diameter part 52d” means, as will be described later, that the displacement part 62c is disposed to allow the restricting part 62 to be securely engaged with the terminal-member main body 5 according to the shape and the position of the reduced-diameter part 52d when, for example, the fitting piece 6 is fitted from the side of the front end portion 52a of the insertion part 52 while being expanded and is attached to the shaft part 52b. The displacement part 62c may be in contact with the reduced-diameter part 52d or may be in a state not contacting with the reduced-diameter part 52d (state where the displacement part 62c is slightly separated from the surface of the reduced-diameter part 52d) as long as the displacement part 62c is configured so as to be positioned along the reduced-diameter part 52d. In the present embodiment, the displacement part 62c is disposed along (so as to be fitted into) the reduced-diameter part 52d, the restricting part 62 is engaged with the engagement parts E1 and E2, and the like, and thus axial movement of the fitting piece 6 is restricted. However, for example, movement of the fitting piece 6 may be restricted by fitting the displacement part 62c into a groove-like reduced-diameter part 52d and engaging the displacement part 62c with the groove-like reduced-diameter part 52d, or movement of the fitting piece 6 may be restricted by a friction force due to contact between the surface of the displacement part 62c and the surface of the reduced-diameter part 52d.

As illustrated in FIGS. 4(C) and 6(A), the displacement part 62c is displaced toward the axis of the fitting piece 6. That is, the displacement part 62c is relatively displaced toward the axis of the fitting piece 6 (closer to the axis of the fitting piece 6). Note that the displacement part 62c may be displaced, for example, by bending the fitting piece 6 upon manufacture of the fitting piece 6, or may be displaced before the fitting piece 6 is assembled to the terminal-member main body 5. In the present embodiment, as illustrated in FIGS. 4(C) and 6(A), the reduced-diameter part 52d is a tapered part reduced in diameter toward the rear end, and the displacement part 62c is displaced toward the inside of the fitting piece 6 correspondingly to the tapered part. More specifically, the restricting part 62 is bent inward at the central part in the axial direction, and includes a flat part 62d extending in the axial direction nearly in parallel to the axis of the fitting piece 6 and the tapered displacement part 62c inclined with respect to the flat part 62d. The tapered displacement part 62c is displaced to the side of the reduced-diameter part 52d illustrated as a tapered part. Here, the displacement part 62c may be displaced “correspondingly to the tapered part” in any manner as long as the displacement part 62c is displaced at a position and within a range where the displacement part 62c does not interfere with the reduced-diameter part 52d illustrated as the tapered part, does not deform the shape of the tapered part, and does not inhibit the connection between the terminal member 4 and the mating member 3. The displacement part 62c is not necessarily formed into a tapered shape. For example, the displacement part 62c may be curved or may be configured to project stepwise to the inside of the fitting piece 6. In addition, in a case where the displacement part 62c is formed into a tapered shape, the taper angle of the displacement part 62c may be substantially identical to or different from the taper angle of the tapered part of the reduced-diameter part 52d.

As described above, as illustrated in FIG. 2, the fitting piece 6 is fitted to from the front end side (front end portion 52a) of the insertion part 52 with a tool or the like. At that time, the restricting parts 62 of the fitting piece 6 expand outward in the radial direction while being elastically deformed. If the fitting piece 6 is further fitted toward the rear end side of the insertion part 52 in that state, the substantially ring-shaped base part 63 is elastically deformed and expanded by the front end portion 52a of the insertion part 52. When the substantially ring-shaped base part 63 goes beyond the front end portion 52a, the fitting piece 6 returns to the original shape and is fitted to the shaft part 52b. In this state, the end part 62a on the front end side of the restricting part 62 and the end part 62b on the rear end side of the restricting part 62 are engaged with the engagement parts E1 and E2, respectively, the fitting piece 6 is sandwiched between the engagement parts E1 and E2 and is fitted to the shaft part 52b of the insertion part 52, and thus the fitting piece 6 is attached to the terminal-member main body 5.

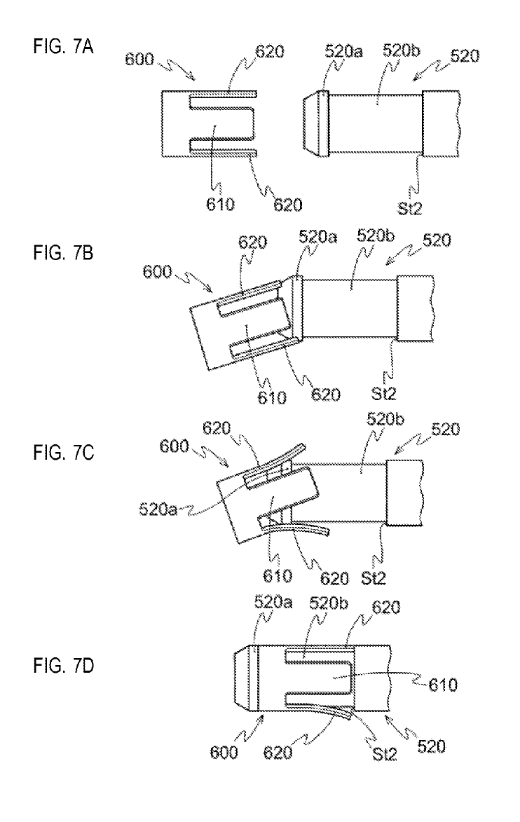

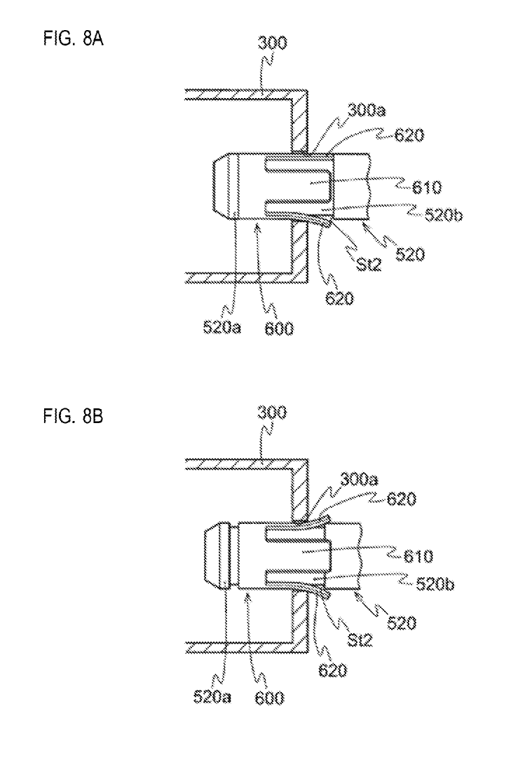

As illustrated in the above-described Patent Document 1, also in the case of a conventional structure, a structure including an substantially ring-shaped base part and a restricting part exists, and a fitting piece is attached to an insertion part in a similar attachment manner. A case of attaching the fitting piece to the insertion part in this conventional structure will be described with reference to FIGS. 7(A) to 7(D), 8(A), and 8(B).

In the conventional structure, as illustrated in FIG. 7(A), a shaft part 520b does not include a reduced-diameter part, and a restricting part 620 is provided in parallel to the axis of the fitting piece 600. From the state illustrated in FIG. 7(A), front end parts of the restricting parts 620 of the fitting piece 600 are inserted and attached to a front end portion 520a of an insertion part 520. However, when the fitting piece 600 is strongly inserted to the insertion part 520, unless the fitting piece 600 is pushed in a state where the fitting piece 600 and the insertion part 520 are coaxial with each other and, additionally, a force is evenly applied to the fitting piece 600, the axis of the fitting piece 600 may be inclined with respect to the axis of the insertion part 520 as illustrated in FIG. 7(B). If the fitting piece 600 is strongly pushed to the insertion part 520 in this state, at least one restricting part 620 (restricting part 620 on the lower side in FIG. 7(C)) may be plastically deformed as illustrated in FIG. 7(C). In such a case, if the fitting piece 600 is further inserted to the insertion part 520 in this state, even though the fitting piece 600 is attached to a shaft part 520b of the insertion part 520, the plastically deformed restricting part 620 is not engaged with a step part St2 on the rear end side of the shaft part 520b of the insertion part 520, as illustrated in FIG. 7(D), and axial movement of the fitting piece 600 with respect to the insertion part 520 cannot be restricted. That is, as illustrated in FIG. 8(A), if the insertion part 520 is inserted into an insertion opening part 300a of a mating member 300 in a state where an end part on the rear end side of the restricting part 620 cannot be engaged with the step part St2 on the rear end side of the shaft part 520b, an opening edge of the insertion opening part 300a and an elastic part 610 which expands outward are brought into contact with each other. If the insertion part 520 is further inserted in that state after the opening edge of the insertion opening part 300a and the elastic part 610 are brought into contact with each other, the elastic part 610 receives a reaction force toward the right side in the figure from the opening edge of the insertion opening part 300a, and the fitting piece 600 receives a force toward the right side from the opening edge. One of the restricting parts 620 of the fitting piece 600 is plastically deformed and is not engaged with the step part St2, resulting in the fitting piece 600 being unstably fitted to the shaft part 520b. Therefore, if the insertion part 520 is further inserted into the insertion opening part 300a in that state, the fitting piece 600 which is unstably fitted goes beyond the step St2 of the shaft part 520b and gets on a portion away from the axis of the shaft part 520b as illustrated in FIG. 8(B). In such a case, a terminal member may not be able to be attached well to a mating member. It may be necessary to attach the fitting piece 600 after applying post-processing or processing for correction to the fitting piece 600, or to replace the fitting piece 600 before attaching the fitting piece 600 again.

In contrast, in the terminal connection structure 1 according to the present invention, as illustrated in FIG. 6(A), the shaft part 52b includes the reduced-diameter part 52d, the restricting part 62 includes the displacement part 62c, and the fitting piece 6 is attached to the terminal-member main body 5 such that the displacement part 62c is positioned along the reduced-diameter part 52d. Therefore, the displacement part 62c displaced toward the axis of the fitting piece 6 enters inside, in the radial direction, of the terminal member 4 toward the reduced-diameter part 52d, and the both ends in the axial direction of the restricting part 62 of the fitting piece 6 are engaged with the terminal-member main body 5. Then, even if the restricting part 62 expands outward to some extent when the fitting piece 6 is attached from the front end portion 52a side of the insertion part 52, since the displacement part 62c is displaced toward the axis of the fitting piece 6, the displacement part 62c is disposed along the reduced-diameter part 52d, that is, disposed such that the displacement part 62c is not separated from the reduced-diameter part 52d to the extent that the displacement part 62c gets on the engagement part E2 on the rear end side. Therefore, even in a case where the restricting part 62 (displacement part 62c) expands outward to some extent and is plastically deformed to some extent upon insertion, the restricting part 62 can still be engaged with the shaft part 52b.

In addition, as illustrated in FIG. 6(B), even in a case where the restricting part 62 is plastically deformed to a relatively large extent, the restricting part 62 of the fitting piece 6 is displaced to the inside due to the existence of the displacement part 62c before the fitting piece 6 is attached to the terminal-member main body 5. Accordingly, even if the restricting part 62 is plastically deformed to some extent, the restricting part 62 is more securely engaged with the shaft part 52b than in the conventional structure. In a state where the fitting piece 6 is fitted to the shaft part 52b (see FIG. 5(A)), if the insertion part 52 of the terminal-member main body 5 is inserted into the insertion opening part 3a of the mating member 3 (see FIG. 5(B)), the elastic part 61 is brought into contact with the opening edge of the insertion opening part 3a, and the elastic part 61 receives a reaction force toward the right side in FIG. 5(B) from the opening edge of the insertion opening part 3a. At that time, as illustrated in FIG. 6(A), the displacement part 62c enters inside, in the radial direction of the terminal member, toward the reduced-diameter part 52d, and the both ends in the axial direction of the restricting part 62 are engaged with the terminal-member main body 5. Alternatively, as illustrated in FIG. 6(B), even if the restricting part 62 is deformed, the both ends in the axial direction of the restricting part 62 are engaged with the terminal-member main body 5. Therefore, with the displacement part 62c and the reduced-diameter part 52d, the rear end part 62b of the restricting part 62 does not go beyond the engagement part E2 even if the fitting piece 6 receives a reaction force from the opening edge of the insertion opening part 3a when the insertion part 52 is inserted into the insertion opening part 3a, and axial movement of the fitting piece 6 with respect to the terminal-member main body 5 is restricted.

In addition, in FIGS. 5(A) to 5(C), a description has been given regarding restriction of axial movement of the fitting piece 6 when the terminal member 4, to which the fitting piece 6 has already been attached, is attached to the mating member 3. The same effect is achieved when the fitting piece 6 is attached to the insertion part 52 with a tool. For example, when the fitting piece 6 is attached to the insertion part 52, only the fitting piece 6 is attached to the tool and the insertion part 52 is pushed and inserted into the fitting piece 6 from the rear end side of the fitting piece 6 attached to the tool, and thus the fitting piece 6 is attached to the insertion part 52. In the conventional structure, if the insertion part 520 is further pushed to the tool in a state where the fitting piece 600 has already been fitted to the insertion part 520, the rear end part of the restricting part 620 may get on the step part St2. In contrast, in the terminal member 4 including the reduced-diameter part 52d and the displacement part 62c, as described above, even in a case where the restricting part 62 is plastically deformed upon insertion, engagement between the restricting part 62 and the shaft part 52b can be maintained. Therefore, also when the fitting piece 6 is attached to the insertion part 52, the rear end part 62b of the restricting part 62 does not go beyond the engagement part E2, and axial movement of the fitting piece 6 with respect to the terminal-member main body 5 can be restricted.

In addition, in a case where the engagement parts E1 and E2 engaged with the restricting part 62 are provided at the front end side and the rear end side of the shaft part 52b, respectively, the front end part 62a and the rear end part 62b of the restricting part 62 are engaged with the engagement parts E1 and E2, respectively, and the reduced-diameter parts 52d are provided adjacent to the engagement parts E1 and E2, engagement between the front end part 62a of the restricting part 62 and the engagement part E1, and engagement between the rear end part 62b of the restricting part 62 and the engagement part E2 have been completed when the fitting piece 6 is attached to the terminal-member main body 5, and the front end part and the rear end part of the restricting part 62 are prevented from getting on the engagement parts E1 and E2, respectively. Therefore, axial movement of the fitting piece 6 with respect to the terminal-member main body 5 is restricted.

In addition, in the present embodiment, the reduced-diameter part 52d is provided adjacent to the engagement part E2 on the rear end side, and the displacement part 62c is provided on the rear end side of the restricting part 62. The engagement part E2 on the rear end side is a portion with which the rear end part 62b of the restricting part 62 is engaged when the insertion part 52 is inserted into the insertion opening part 3a or when the fitting piece 6 is attached to the insertion part 52 with a tool. Therefore, in a case where the reduced-diameter part 52d is provided adjacent to the engagement part E2 on the rear end side and the displacement part 62c is provided on the rear end side of the restricting part 62, the rear end part 62b of the restricting part 62 and the engagement part E2 of the rear end side are more securely engaged with each other. That is, engagement of the restricting part 62 can be secured in various states between the state of the displacement part 62c illustrated in FIG. 6(A) (a case where the restricting part 62 is hardly plastically deformed) and the state of the displacement part 62c illustrated in FIG. 6(B) (a case where the restricting part 62 expands outward and is plastically deformed). Therefore, the allowable deformation range of the restricting part 62 upon insertion to the insertion part 52 can be made greater than in the conventional structure. Furthermore, since the reduced-diameter part 52d is provided, it is not necessary to increase the diameter of the rear end portion 52c of the insertion part 52 in order to form the engagement part E2 on the rear end side, the size of the insertion opening part 3a of the mating member 3 into which the rear end portion 52c of the insertion part 52 is inserted can be made small, and the mating member 3 can be made compact.

In addition, in the present embodiment, the reduced-diameter part 52d is a tapered part reduced in diameter toward the rear end, and the displacement part 62c is displaced toward the inside of the fitting piece correspondingly to the tapered part. In a case where the reduced-diameter part 52d is formed into a groove without the length in the axial direction, dimensional accuracy is required in order to align the axial positions of the reduced-diameter part 52d and the displacement part 62c. However, in a case where the reduced-diameter part 52d is formed into a tapered part reduced in diameter toward the rear end, even if there is a dimensional error in the axial direction of the displacement part 62c, the dimensional error is absorbed and the displacement part 62c can be easily positioned along the tapered surface of the tapered part. The fitting piece 6 can also be easily attached, and the rear end part 62b of the restricting part 62 is more securely engaged with the engagement part E2 on the rear end side.

In addition, in the present embodiment, the restricting part 62 has spring elasticity, and the displacement part 62c is configured to be displaced so as to be brought into contact with the reduced-diameter part 52d by an elastic force due to the spring elasticity in a state where the fitting piece 6 is mounted to the terminal-member main body 5. Due to the spring elasticity of the restricting part 62, at least part of the displacement part 62c of the restricting part 62 is brought into contact with the reduced-diameter part 52d. More specifically, when the fitting piece 6 is mounted to the terminal-member main body 5, the displacement part 62c displaced toward the axis of the fitting piece 6 once expands outward, and then returns to be displaced inward due to the spring elasticity. The end part (rear end part 62b of the restricting part) on the rear end side of the displacement part 62c returned to be displaced inward due to the spring elasticity of the restricting part 62 (or the entire inside surface of the displacement part 62c) is brought into contact with the tapered part of the reduced-diameter part 52d. As described above, in a case where the restricting part 62 has spring elasticity and the displacement part 62c is brought into contact with the surface of the reduced-diameter part 52d due to the elastic force of the spring elasticity, the restricting part 62 is more securely engaged with the terminal-member main body 5. Therefore, axial movement of the fitting piece 6 can be more reliably restricted.

### REFERENCE SIGNS LIST

1: Terminal connection structure
2: Long member
21a, 21b, 21c: Terminal
22a, 22b, 22c: Inner cable
23a, 23b, 23c: Outer casing
3: Mating member
3a: Insertion opening part
3b: Inside engagement part
4: Terminal member
5: Terminal-member main body
51: Attachment part
51a: Locking recess
51b: End surface of attachment part
51c: Guide groove
52: Insertion part
52a: Front end portion of insertion part
52b: Shaft part of insertion part
52c: Rear end portion of insertion part
52d: Reduced-diameter part
52e: Columnar part
6: Fitting piece
61: Elastic part
62: Restricting part
62a: Front end part of restricting part
62b: Rear end part of restricting part
62c: Displacement part
62d: Flat part
63: Base part
C: Joint case
E1, E2: Engagement part
S: Internal space
SL: Slit

1. A terminal connection structure comprising a terminal member to which a terminal of a long member is attached and which is connected to a mating member: the terminal member being inserted into an insertion opening part of the mating member and connected to the mating member wherein;
the terminal member includes
a terminal-member main body including an attachment part to which the terminal of the long member is attached and an insertion part which extends from the attachment part and is inserted into the insertion opening part, and
a fitting piece which is fitted to the insertion part of the terminal-member main body;
the fitting piece includes
elastic parts which deform elastically when the elastic parts are inserted into the insertion opening part and are engaged with an inside engagement part of the mating member by expanding after the elastic parts are inserted into the insertion opening part, and
restricting parts which extend in an axial direction of the insertion part between the elastic parts and restrict movement of the fitting piece in the axial direction of the insertion part with respect to the insertion part by engaging the terminal-member main body to end of the restricting parts in both side;
the insertion part includes a shaft part which extends in the axial direction and is provided with a reduced-diameter part that is reduced in diameter toward one side in the axial direction,
the restricting part includes a displacement part which is displaced inwardly in an axial direction of the fitting piece, and
the fitting piece is attached to the terminal-member main body with the displacement part positioned along the reduced-diameter part.

2. The terminal connection structure according to claim 1, wherein
engagement parts engaged with the restricting parts are provided on a front end side and a rear end side of the shaft part,
a front end part and a rear end part of each of the restricting parts are engaged with the engagement parts, and
the reduced-diameter part is provided adjacent to at least one engagement part.

3. The terminal connection structure according to claim 1, wherein the reduced-diameter part is a tapered part which is reduced in diameter toward a rear end, and the displacement part is displaced toward inside of the fitting piece correspondingly to the tapered part.

4. The terminal connection structure according to claim 1, wherein each of the restricting parts has spring elasticity, and the displacement part is displaced so as to be brought into contact with the reduced-diameter part by an elastic force due to the spring elasticity in a state where the fitting piece is mounted to the terminal-member main body.

5. The terminal connection structure according to claim 2, wherein the reduced-diameter part is a tapered part which is reduced in diameter toward a rear end, and the displacement part is displaced toward inside of the fitting piece correspondingly to the tapered part.

6. The terminal connection structure according to of claim 2, wherein each of the restricting parts has spring elasticity, and the displacement part is displaced so as to be brought into contact with the reduced-diameter part by an elastic force due to the spring elasticity in a state where the fitting piece is mounted to the terminal-member main body.

7. The terminal connection structure according to of claim 3, wherein each of the restricting parts has spring elasticity, and the displacement part is displaced so as to be brought into contact with the reduced-diameter part by an elastic force due to the spring elasticity in a state where the fitting piece is mounted to the terminal-member main body.
